(19) United States
(12) Patent Application Publication
(10) Pub. No.: US 2002/0100047 A1
(43) Pub. Date: Jul. 25, 2002

(54) Method of recording programs recommended by opinion leader selected by user, and apparatus for automatically recording broadcasts

(75) Inventors: Hiroshi Matoba, Tokyo (JP); Hidetaka Hane, Tokyo (JP); Akihisa Kenmochi, Tokyo (JP); Jun-Ichi Yamato, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/046,852

(22) Filed: Jan. 15, 2002

(30) Foreign Application Priority Data
Jan. 22, 2001 (JP) 2001-013586

(51) Int. Cl. H04N 5/445

(52) U.S. Cl. 725/46; 725/89

(57) ABSTRACT

There are disclosed a method of and an apparatus for automatically recording programs recommended by opinion leaders selected by the user. A timer recording pattern server discloses timer recording pattern information including identification codes of programs recommended by the opinion leaders through the Internet for the respective opinion leaders. An automatic broadcast recording apparatus acquires the timer recording pattern information of an opinion leader selected by the user via the Internet. The automatic broadcast recording apparatus acquires program information including identification codes of the broadcast programs and broadcasting dates and times thereof. The automatic broadcast recording apparatus selects a program included in the timer recording pattern information from the program information and sets the program for timer recording. Thereafter, the automatic broadcast recording apparatus receives the program set for timer recording and records the program.

### BACKGROUND OF THE INVENTION

1. Field of the Invention

The present invention relates to an apparatus for automatically recording and accumulating programs that are broadcast.

2. Description of the Related Art

If the user of a television set will be unable to see a television program on a real-time basis, then the user occasionally sets his video recorder to a timer recording mode to record the program and will subsequently see the recorded program on the video recorder. According to one general timer recording process, the user refers to a table of television programs in a newspaper, a magazine, or the like, selects a television program that the user wants to see, and sets the time and channel of the program or an identification code assigned to the program in the video recorder.

Digital broadcasting services which use communication satellites broadcast an EPG (Electronic Program Guide) as program information containing programs to be broadcast and times at which they will be broadcast. Using a receiver with an EPG receiving function, the user is able to refer to a program table displayed on the television screen and use the displayed program table instead of a table of television programs in a newspaper, a magazine, or the like. Some EPGs may be available via telephone lines or ISDN lines other than broadcasts.

When the digital broadcasting services become full-fledged with CS broadcasting and CATV in widespread use, the number of television channels that can be received by user's terminals greatly increases. If the number of receivable television channels exceeds 100, then the amount of program information becomes huge. With the huge amount of program information presented to the user, it is a time-consuming and tedious task for the user to refer to a newspaper, a magazine, or an EPG to select a television program or programs for timer recording or real-time viewing. The user may overlook a television program or programs to be seen or recorded, and fail to set timer recording to record such a television program or programs.

Even in the case of present-day ground-based broadcasts with a small number of channels, the program is often over before the viewer notices it because the viewer forgets to see a table of programs. One solution is to use an automatic broadcast recording apparatus for automatically selecting and recording programs that are broadcast.

The automatic broadcast recording apparatus learns the user's taste based on the user's viewing history and the EPG, automatically selects programs that meet the user's taste from the programs that are broadcast, and records and accumulates the selected programs.

The user to select individual programs, but the automatic broadcast recording apparatus presumes certain programs to be the ones that the user may want to see. Therefore, in order to record programs that the user may want to see without fail, the automatic broadcast recording apparatus should preferably accumulate as many programs that are expected to be seen by the viewer as possible. The automatic broadcast recording apparatus thus uses a program storage memory area to its almost full capacity at all times, selects programs to be left in the program storage memory area, and records the new programs in the program storage memory area and deletes programs stored in the past from the program storage memory area based on the selections. One simple method of determining programs to be deleted from the program storage memory area is to delete programs in the same order that they are recorded.

According to one method of selecting programs in view of the user's satisfaction, when the user's taste is studied based on the user's viewing history including information of the programs that the user has seen in the past and the EPG, the user's taste is classified into a plurality of levels, i.e., a plurality of values for the user, and those programs which belong to higher levels of the user's taste are left recorded and those programs which belong to lower levels of the user's taste are deleted.

According to another conventional automatic program recording method, keywords or the like that indicate the user's taste are preset in the automatic broadcast recording apparatus and then the automatic broadcast recording apparatus automatically selects and records programs that meet the user's taste from the EPG using the keywords. The keywords may be associated with different levels of the user's taste to select programs to be left and programs to be deleted when there are programs to be recorded in excess of the program storage capacity.

Still another conventional automatic program recording method uses a process called collaborative filtering in presuming some programs to meet the user's taste. According to the collaborative filtering, timer recording actions of those who have similar viewing histories are shared among a plurality of users. According to the automatic program recording method incorporating the collaborative filtering, a number of users are classified into groups having similar tastes based on their viewing histories, and programs that are selected for timer recording by many users in one group are judged as meeting the taste of that group, and are automatically recorded for all the users of the group even if the timer recording is not set by every user of the group.

The above conventional apparatus and methods suffer the following problems:

At present, the data contained in the EPG are not detailed enough, and it is difficult to determine the contents of programs from the EPG data and select programs that meet the user's taste based on the EPG data. It is also difficult to group programs that are to be recorded depending on the user's taste into different levels based on the EPG data. Furthermore, since it takes a certain period of time for the automatic broadcast recording apparatus to learn the user's taste, the user cannot expect the automatic broadcast recording apparatus to automatically record all the programs that meets the user's taste without fail until the presuming accuracy of the automatic broadcast recording apparatus becomes sufficiently high.

According to the method of automatically selecting programs from the EPG based on keywords or the like that represent the user's taste, the user needs to manually enter various keywords into the automatic broadcast recording apparatus, and the manual process of entering keywords or the like is tedious and time-consuming. In addition, programs that the user wants to see may not be recorded unless the use enters all the keywords that are required. Inasmuch as the EPG can be edited with a view to easily selecting programs in a keyword search, it occasionally tends to happen that programs that do not meet the user's taste may actually be recorded by keywords.

According to the method using the collaborative filtering, the viewing histories of users need to be accumulated over a certain period of time in order to build a sufficient database so as to be able to determine groups into which the users are to be classified. In an initial stage of the process, therefore, it cannot be expected that all programs that meet the user's taste will be automatically recorded without fail. According to this method, furthermore, because programs to be recorded are selected based on the viewing histories of unspecified users belonging to one group, the users are unaware of and anxious about the criteria used by the automatic broadcast recording apparatus to determine which programs are to be automatically recorded. In this method, while the automatic broadcast recording apparatus selects programs to be recorded based on timer recording actions of other users, the user often finds that programs thus recorded do not meet the user's taste when the user actually views those programs. In this method, a central server collects and analyzes the viewing histories of a number of users. However, inasmuch as the process of recognizing the tastes of the many users from their viewing histories is complex, it imposes a large burden on the central server to perform that process for all the users.

### SUMMARY OF THE INVENTION

It is an object of the present invention to provide a method of and an apparatus for automatically recording broadcasts according to an easy process to reliably reflect the user's taste immediately after the method and the apparatus have started to be used, using criteria, which are clear to the user, for determining which programs are to be automatically recorded.

To achieve the above object, in accordance with the present invention, a broadcast recording apparatus selects a program which meets a user's taste from broadcast programs, and automatically records the selected program. Some programs include both video and audio data, and some programs include only audio data.

According to the present invention, there are some opinion leaders serving to recommend programs to be appreciated to the user. Timer recording pattern information to record programs recommended by the opinion leaders are disclosed with respect to each opinion leader. The user records the program recommended by the opinion leader selected by the user on an automatic broadcast recording apparatus. According to another aspect of the present invention, timer recording pattern information for recording programs selected according to respective selecting standards, rather than opinion leaders, is disclosed. Such selecting criteria can be used in the same manner as opinion leaders insofar as the selecting criteria are clear.

The automatic broadcast recording apparatus has information acquiring means, timer recording means, receiving means, and recording and playing means. The automatic broadcast recording apparatus acquires timer recording pattern information for recording programs recommended by an opinion leader who is selected by the user by the information acquiring means and sets timer recording for a program determined by the timer recording pattern information by the timer recording means. The automatic broadcast recording apparatus receives the program set for timer recording by the receiving means, and records the program by the recording and playing means.

Since a program recommended by an opinion leader selected by the user is automatically recorded, it is easy for the user to select the program to be recorded. The program to be recorded can be selected even if insufficient information for selecting the program is carried by an EPG. The automatic broadcast recording apparatus appropriately selects the program to be set for timer recording immediately after the automatic broadcast recording apparatus starts being used. According to the invention, the user does not need to enter keywords for extracting preferred programs without fail, and can easily select programs. The user is not anxious about selecting criteria which are clear to the user because programs recommended by the opinion leader are selected as the timer recording pattern information, and it is less likely for the user to find the recommended programs uninteresting when the user actually views them.

According to another aspect of the present invention, the information acquiring means acquires program information including program identification codes of programs to be broadcast and broadcasting date and times thereof. The timer recording pattern information includes start-of-program times and end-of-program times of the programs recommended by the opinion leader. The timer recording means selects the program determined based on the timer recording pattern information from the program information and sets the program for timer recording. The programs recommended by the opinion leader can thus automatically be recorded.

According to still another aspect of the present invention, the recording and playing means records a playback history, a timer recording history, or a recording history, and automatically selects an opinion leader which meets the users taste from the recorded history. After the user's taste has been recognized, the user is not required to select an opinion leader, and finds it easy to select programs to be recorded. The playback history contains information of whether recorded programs have been played back or not. The timer recording history contains information of programs set for timer recording. The recording history contains information of recorded programs.

According to yet another aspect of the present invention, when the information acquiring means acquires new program information, the timer recording means confirms the broadcasting dates and times of programs to be recorded, and corrects, if necessary, the broadcasting dates and times of the programs set for timer recording. Therefore, the program is prevented from failing to be recorded due to a change in the broadcasting date and time.

In another method of automatically recording a program according to the present invention, broadcast programs are recorded to accumulate programs which meet the user's taste. The recording and playing means sends information of playback statuses of recorded programs to a server. The server collects the information of playback statuses sent from the respective users, calculates a priority level estimating how much a program meets the user's taste, and sends the priority level to each user. The recording and playing means deletes programs successively from those of lower priority levels when it deletes recorded programs. Any processing load on the server is low because the server only estimates the overall tendency of the users and does not need to estimate the taste of each user.

According to still yet another aspect of the present invention, if a program recorded in the past needs to be deleted in order to record a new program, the recording and playing means compares a predetermined priority level given to the new program with the priority level of the program recorded in the past. If there is a program whose priority level is lower than the new program among programs recorded in the past, the recording and playing means deletes the program whose priority level is lower than the new program, and records the new program. If there is no program whose priority level is lower than the new program among programs recorded in the past, the recording and playing means does not record the new program.

In another method of automatically recording a program according to the present invention, actions on programs of users in a group of users having similar appreciating histories are shared through the server between those users. The actions of the users in the same group are used when programs to be accumulated are selected. The automatic broadcast recording apparatus sends information of playback statuses of recorded programs to the server. The server collects the information of playback statuses sent from the respective users, calculates a priority level estimating how much a program meets the user's taste for each group, and sends the priority level to each user belonging to the group. The automatic broadcast recording apparatus deletes programs successively from those of lower priority levels when it deletes recorded programs. Inasmuch as programs to be deleted are selected based on the actual playback statuses of other users belonging to the same group, programs which better meet the user's taste can be left in storage.

According to a further aspect of the present invention, the server comprises a computer which has a processor, a recording device, etc., and is capable of executing a software program. The automatic broadcast recording apparatus incorporates a processor, a recording device, etc., and is capable of executing a software program which includes the processes of the above various means.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram of an automatic broadcast recording system according to an embodiment of the present invention;

FIG. 2 is a block diagram of an automatic broadcast recording apparatus according to the embodiment;

FIG. 3 is a block diagram of a timer recording pattern server according to the embodiment; and

FIG. 4 is a block diagram of an automatic broadcast recording apparatus according to another embodiment of the present invention.

### DESCRIPTION OF THE PREFERRED EMBODIMENTS

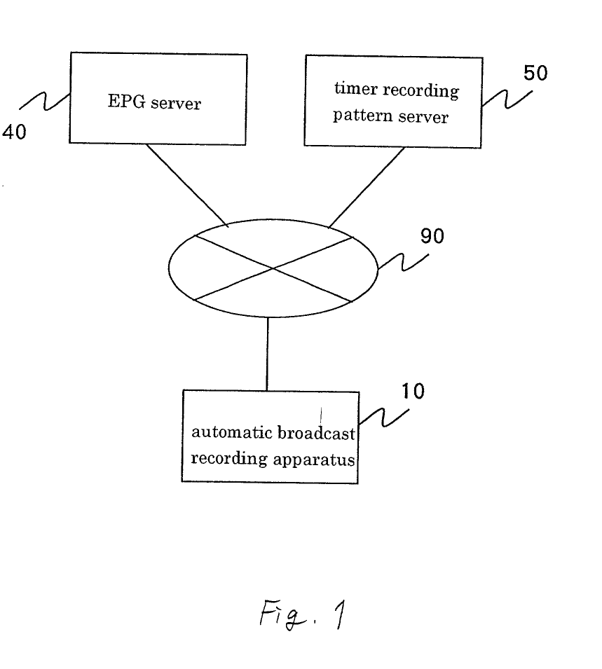

Referring now to FIG. 1, there is shown an automatic broadcast recording system according to an embodiment of the present invention, which comprises automatic broadcast recording apparatus 10, EPG server 40, and timer recording pattern server 50.

Automatic broadcast recording apparatus 10 is an apparatus for automatically recording a program that is transmitted on a radio wave from a broadcasting station (not shown). Automatic broadcast recording apparatus 10 is connected to EPG server 40 and timer recording pattern server 50 via Internet 90 for transmitting data thereto and receiving data therefrom. EPG server 40 refers to a web server that can be accessed via Internet 90, and discloses program titles and program identification codes for identifying programs that are to be broadcast, and an EPG (Electronic Program Guide) which provides program information representing dates, times, and channels for broadcasting the programs. Timer recording pattern server 50 refers to a web server that can be accessed via Internet 90, and discloses various items of timer recording pattern information selected by opinion leaders. The opinion leaders refer to famous people in various fields, and specify programs that they recommend to the user for timer recording according to timer recording pattern information. The timer recording pattern information represents, for example, program identification codes of programs that are recommended by opinion leaders. When the user refers to the EPG based on a program identification code represented by the timer recording pattern information, the user can obtain the start-of-program and end-of-program times and the channel of the program. When the user has obtained the start-of-program and end-of-program times and the channel of the program, the user is able to set timer recording for the program.

In the timer recording pattern information, a plurality of programs are usually recommended. The user chooses an opinion leader who is likely to recommend programs that meet the user's taste, and uses the timer recording pattern information provided by the opinion leader for timer recording of programs. The user is allowed to choose a plurality of opinion leaders.

A plurality of programs recommended by an opinion leader need to meet the user's taste. For example, if an opinion leader is chosen less frequently by the user, then that opinion leader may be replaced with another opinion leader to improve the opinion leader's recommendations.

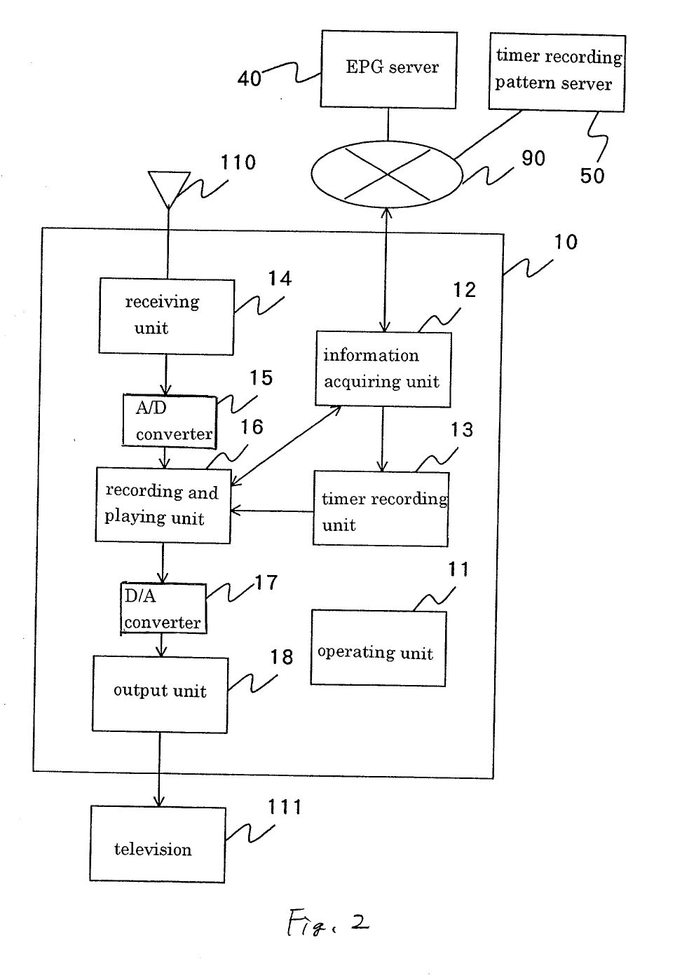

As shown in FIG. 2, automatic broadcast recording apparatus 10 comprises operating unit 11, information acquiring unit 12, timer recording unit 13, receiving unit 14, analog-to-digital converting unit 15, recording and playing unit 16, digital-to-analog converting unit 17, and output unit 18.

Automatic broadcast recording apparatus 10 acquires an EPG from EPG server 40, acquires the timer recording pattern information of an opinion leader which the user desires from timer recording pattern server 50, selects a program specified by the timer recording pattern information from the EPG, and sets timer recording for the selected program. Operating unit 11 is a user interface for obtaining the EPG and the timer recording pattern information. Operating unit 11 is also operated by the user for specifying an individual program and setting timer recording therefor, and also manually recording a program without setting timer recording. Operating unit 11 is also operated by the user for playing back a recorded program. Operating unit 11 detects a command entered by the user and transmits the detected command to various units of automatic broadcast recording apparatus 10. Information acquiring unit 12 accesses EPG server 40 and acquires an EPG therefrom. Information acquiring unit 12 also accesses timer recording pattern server 50 and acquires timer recording pattern information therefrom. Timer recording unit 13 selects programs specified by the timer recording pattern information acquired by information acquiring unit 12 from the EPG acquired by information acquiring unit 12, and sets timer recording for the selected programs. Receiving unit 14 receives a radio wave transmitted from a broadcasting station, not shown, via antenna 110, and provides the received signal. Analog-to-digital converting unit 15 (referred to as A/D converter in FIG. 2) converts the analog signal from receiving unit 14 into a digital signal. Recording and playing unit 16 records the programs selected by timer recording unit 13. Thereby, video and audio data are recorded. Recording and playing unit 16 extracts recorded video and audio data. Digital-to-analog converting unit 17 (referred to as D/A converter in FIG. 2) converts the digital video and audio data from recording and playing unit 16 into an analog signal. Output unit 18 transmits the analog signal from digital-to-analog converting unit 17 to television 111.

Operation of automatic broadcast recording apparatus 10 will be described below.

Automatic broadcast recording apparatus 10 acquires an EPG from EPG server 40 through information acquiring unit 12. Automatic broadcast recording apparatus 10 may periodically access EPG server 40 to acquire an EPG, or may acquire an EPG based on a command entered into operating unit 11 by the user. Automatic broadcast recording apparatus 10 also accesses timer recording pattern server 50 based on a command entered into operating unit 11 by the user, and acquires the timer recording pattern information of an opinion leader which the user desires through information acquiring unit 12.

Then, automatic broadcast recording apparatus 10 selects programs specified by the timer recording pattern information from the EPG, and sets timer recording for the selected program through timer recording unit 13. According to one process of selecting a program for timer recording, automatic broadcast recording apparatus 10 acquires the timer recording pattern information of one opinion leader, and sets timer recording for all the programs specified by the timer recording pattern information. According to another process of selecting a program for timer recording, automatic broadcast recording apparatus 10 acquires a plurality of items of timer recording pattern information, and sets timer recording for programs determined by a logic operation such as OR operation or AND operation that is carried out on the acquired items of timer recording pattern information. For example, the user can preset, in automatic broadcast recording apparatus 10, a plurality of opinion leaders and a logic operation formula for performing a logic operation on the items of timer recording pattern information provided by the opinion leaders. Then, automatic broadcast recording apparatus 10 acquires the items of timer recording pattern information according to the setting, and sets timer recording for programs that are obtained by effecting the logic operation on the acquired items of timer recording pattern information. Unless the settings of the opinion leaders and the logic operation formula are changed, automatic broadcast recording apparatus 10 repeats the above timer recording process.

Then, when the start-of-program time for the program set for timer recording is reached, in automatic broadcast recording apparatus 10, receiving unit 14 receives the program, and recording and playing unit 16 records the video and audio data of the program.

For playing back a desired program, the user enters a command into commanding unit 11 to cause recording and playing unit 16 to extract the video and audio data of the desired program. The extracted video and audio data is converted by digital-to-analog converting unit 17 into a video and audio signal, which is transmitted to television 111.

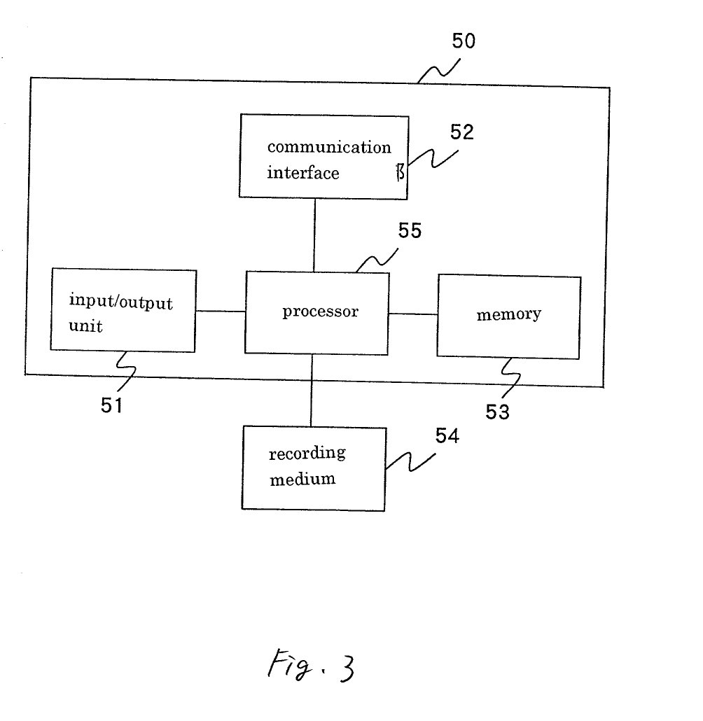

As shown in FIG. 3, timer recording pattern server 50 comprises input/output unit 51, communication interface 52, memory 53, and processor 55, and can be connected to recording medium 54.

Input/output unit 51 is a user interface including a keyboard and a mouse for generating a web page and entering programs selected by opinion leaders as timer recording pattern information into timer recording pattern server 50 and a display unit for displaying an image for making settings. Communication interface 52 transmits data to and receives data from automatic broadcast recording apparatus 10 via Internet 90. Memory 53 stores a program required to operate timer recording pattern server 50 and data such as timer recording pattern information. Recording medium 54 refers to a recording medium such as a floppy disk, a CD-ROM, a magneto-optical disk, or the like, and stores a program for receiving access via Internet 90 and disclosing timer recording pattern information selected by respective opinion leaders. Processor 55 reads the program from recording medium 54 into memory 53 and executes the program. When processor 55 performs its processing sequence, timer recording pattern server 50 discloses the web page generated by an action made through input/output unit 52 on Internet 90, records the timer recording pattern information entered through input/output unit 52, and displays the timer recording pattern information on the web page.

According to the present embodiment, since a program recommended by a selected opinion leader is set for timer recording without the need for the user to check a large amount of program information, it is easy to select the program, the program to be recorded can be selected even if insufficient information for selecting the program is carried by the EPG, and the program to be set for timer recording can be selected immediately after automatic broadcast recording apparatus 10 starts being used.

The user does not have to take the trouble of thinking and entering keywords for extracting preferred programs without fail, and hence there is no danger of failing to enter keywords. The user is not anxious about opinion leaders who recommend programs because the opinion leaders are clear to the user. Because programs recommended by opinion leaders on their own responsibility are disclosed as timer recording pattern information, it is less likely for the user to find the recommended programs uninteresting when the user actually views them. The server is not required to perform a complex process of collecting and analyzing the viewing histories of many users.

Recording and playing unit 16 accumulates as many programs that are expected for the user to want to see as possible in order to record as many programs that the user wants to see without fail. To perform such a function, recording and playing unit 16 uses a program storage memory area to its almost full capacity at all times, selects programs to be left in the program storage memory area, and records new programs in the program storage memory area and deletes programs stored in the past from the program storage memory area based on the selections. The program storage memory area is an area on a randomly accessible recording medium such as a hard disk, a RAM, or the like, which should preferably be removably connected to automatic broadcast recording apparatus 10.

One example of a process of selecting a program in automatic broadcast recording apparatus 10 will be described below. In this example, timer recording pattern server 50 carries out a process of selecting a program in addition to the process described above.

When recording and playing unit 16 plays back a recorded program, it sends playback history information through information acquiring unit 12 to timer recording pattern server 50. The playback history information includes a program title for identifying the program and a playback status of whether the user has played back the program to its end or not. Timer recording pattern server 50 collects the playback history information sent from respective automatic broadcast recording apparatus 10 of the users, and classifies each of the programs viewed by the users into one of a plurality of priority levels (hereinafter referred to as “playback completion levels”) depending on the percentage of users who have played back the program. Timer recording pattern server 50 then sends collected status information including the program titles and the playback completion levels to automatic broadcast recording apparatus 10 of the respective users. The users may be classified into groups each selecting one timer recording pattern information, and the playback completion levels may be collected in each of the groups of the users. When automatic broadcast recording apparatus 10 which has received the collected status information selects a program to be left in the program storage memory area, it stores a program with a higher playback completion level. Specifically, when automatic broadcast recording apparatus 10 deletes a program recorded in the past for the purpose of recording a new program, it preferentially deletes a program of a lower playback completion level. Automatic broadcast recording apparatus 10 cannot give, to a program which is about to be recorded, a playback completion level having reflected the playback history of another user. However, automatic broadcast recording apparatus 10 can compare a program to be broadcast with a program in the program storage memory area by setting the playback completion level of the program to be broadcast to a predetermined value. In this case, if programs whose priorities are lower than the program to be recorded are stored in the program storage memory area, then automatic broadcast recording apparatus 10 deletes the program of the lowest priority from the program storage memory area to provide an area therein for storing the program to be recorded. If programs whose priorities are lower than the program to be recorded are not stored in the program storage memory area, then automatic broadcast recording apparatus 10 does not record the program. Since a program can be selected based on the actual playback statuses of the other users who have chosen the same timer recording pattern information, programs that better meet the user's taste can be left in automatic broadcast recording apparatus 10.

The above process of selecting a program can be applied to a conventional automatic broadcast recording apparatus in which timer recording action of the users who have similar viewing histories are shared by the users with use of the collaborative filtering to select programs to be recorded. In this case, timer recording pattern server may collect the playback completion levels of the users of a group having similar tastes, and sends collected status information each user. When automatic broadcast recording apparatus which has received collected status information selects a program to be stored in the program storage memory area, it selects a program with a higher playback completion level preferentially.

The above process of selecting a program can be used in combination with any other processes of selecting a program to be set for timer recording.

The playback completion level of each program has been described as a criteria indicative of whether the user has played back the program to its end or not. However, a criteria indicative of whether the user has deleted the program, how much the user has played back the program before deleting it, or how the user has answered a program evaluation question asked by the system, or a combination of these criteria may be used as the playback completion level. The present process of selecting a program is effective when a wide range of programs to be recorded are selected, and a program that meets the user's taste is to be left out of the selected programs based on the actual viewing behaviors of other users belonging to the same group.

In the present embodiment, the user chooses opinion leaders. However, automatic broadcast recording apparatus 10 may automatically determine opinion leaders who meet the user's taste based on a playback history, which is recorded by recording and playing unit 16, of programs including automatically recorded programs, programs individually specified by the user and recorded by timer recording, and programs manually recorded without timer recording. The playback history refers to information of whether the program has been played back, whether the program has been played back to the end, or how much the program has been played back. With automatic broadcast recording apparatus 10 automatically choosing opinion leaders, the user is no longer required to take the trouble of choosing opinion leaders. Similarly, a timer recording history which refers to information representing programs automatically set for timer recording and programs individually specified by the user and set for timer recording may be recorded by recording and playing unit 16, and opinion leaders who meet the user's taste can automatically be determined based on the timer recording history. Alternatively, a recording history which refers to information representing automatically recorded programs, programs individually specified by the user and recorded by timer recording, and programs manually recorded without timer recording may be recorded by recording and playing unit 16, and opinion leaders who meet the user's taste can automatically be determined based on the recording history.

The timer recording pattern information of opinion leaders is disclosed on the web page in the present embodiment. However, the timer recording pattern information of opinion leaders may be recorded on a recording medium such as a CD-ROM, and such CD-ROMs may be distributed to users to disclose the timer recording pattern information to the users. In the present embodiment, an EPG is referred to according to a program identification code described in timer recording pattern information, to specify a channel to be recorded and start-of-program and end-of-program times. However, the timer recording pattern information may include the channels of programs recommended by opinion leaders and the broadcasting dates and times of the programs. In this case, automatic broadcast recording apparatus 10 may be set for timer recording according to a channel and start-of-program and end-of-program times which are included in the timer recording pattern information. Thus, automatic broadcast recording apparatus 10 is not required to access EPG server 40. An opinion leader may select a program to be recommended based on program information from EPG server 40, and may acquire program information from newspapers, magazines, or the like. If opinion leaders acquire program information from newspapers or magazines, then EPG server 40 may be dispensed with.

Radio waves received by automatic broadcast recording apparatus 10 may be ground waves or radio waves transmitted via communication satellites. Programs may be broadcast according to a digital broadcasting system or an analog broadcasting system.

While programs have been illustrated as being broadcast by radio waves, the present invention is also applicable to a system in which programs are broadcast through wired lines, such as a CATV system. In such a system, antenna 110 is dispensed with, and receiving unit 14 receives programs broadcast from a wired line.

Television broadcasting programs including video and audio data have been described in the above embodiment. However, the present invention is also applicable to various broadcasting systems such as a radio system where only audio data are broadcast. Programs broadcast in those broadcasting systems can be recorded for subsequent appreciation.

The timer recording pattern information represents programs which are selected by opinion leaders in advance. After an opinion leader has selected a program, the broadcasting date and time of the program may be changed, or the broadcasting date and time of the program may not be determined at the time the opinion leader has selected the program. To handle such a situation, timer recording unit 13 of automatic broadcast recording apparatus 10 may have a function to confirm the broadcasting date and time of a program to be recorded when it acquires an EPG and correct the broadcasting date and time of the program set for timer recording as necessary. For example, if timer recording pattern information includes the start-of-program and end-of-program times of programs, then when automatic broadcast recording apparatus 10 acquires an EPG, it compares the timer recording pattern information with the EPG, and corrects the date and time of timer recording for a program whose times have been changed. If timer recording pattern information does not include the start-of-program and end-of-program times of programs, then automatic broadcast recording apparatus 10 compares an EPG acquired in the past with an EPG acquired at present, and corrects the date and time of timer recording for a program whose times have been changed.

An automatic broadcast recording apparatus according to another embodiment of the present invention will be described below.

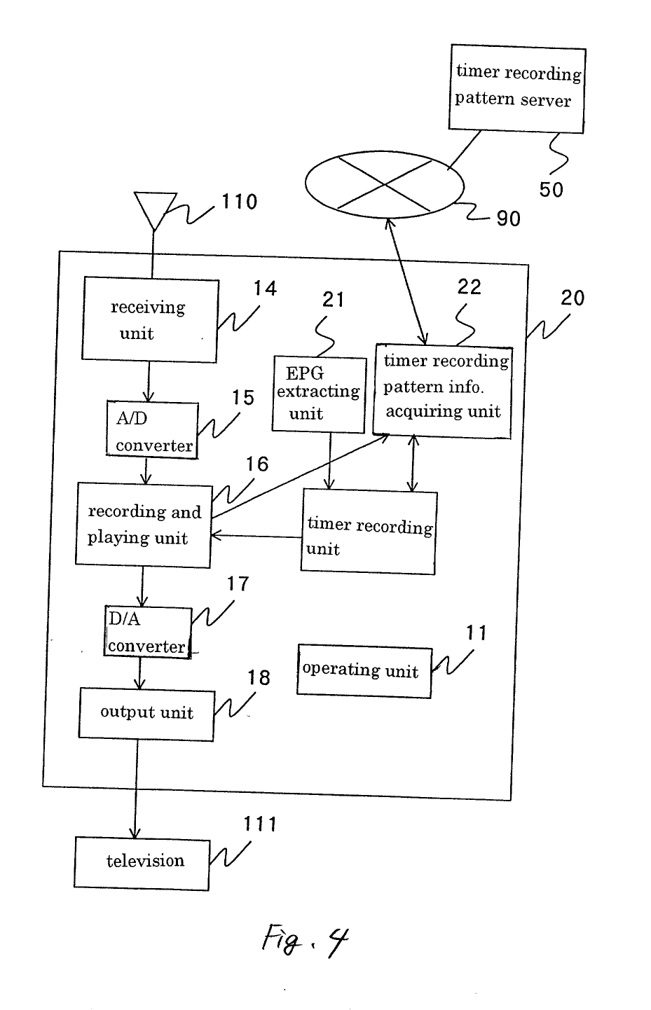

In the embodiment shown in FIG. 4, an EPG is transmitted with a program broadcast by a radio wave. Therefore, EPG server 40 shown in FIG. 1 is dispensed with in the embodiment shown in FIG. 4.

Automatic broadcast recording apparatus 20 comprises operating unit 11, EPG extracting unit 21, timer recording pattern information acquiring unit 22, timer recording unit 13, receiving unit 14, analog-to-digital converting unit 15, recording and playing unit 16, digital-to-analog converting unit 17, and output unit 18.

Operating unit 11, timer recording unit 13, receiving unit 14, analog-to-digital converting unit 15, recording and playing unit 16, digital-to-analog converting unit 17, and output unit 18 are identical to those of automatic broadcast recording apparatus 10 shown in FIG. 1. EPG extracting unit 21 extracts an EPG from a signal received by receiving unit 14, and sends the EPG to timer recording unit 13. Timer recording pattern information acquiring unit 22 gains access to timer recording pattern server 50, acquires timer recording pattern information therefrom, and sends the acquired timer recording pattern information to timer recording unit 13.

Automatic broadcast recording apparatus 20 operates as follows: EPG extracting unit 21 extracts an EPG. Automatic broadcast recording apparatus 20 accesses timer recording pattern server 50 based on a command entered into operating unit 11 by the user, and acquires the timer recording pattern information of an opinion leader which the user desires through timer recording pattern information acquiring unit 22. Then, timer recording unit 13 selects a program specified by the timer recording pattern information, and sets timer recording for the selected program. Receiving unit 14 receives the program at the start-of-program time of the program, and recording and playing unit 16 records the video and audio data of the program. For playing back a desired program, recording and playing unit 16 extracts the video and audio data of the desired program based on a command entered into operating unit 11 by the user. Automatic broadcast recording apparatus 20 then outputs the video and audio data of the desired program to television set 111.

In the above embodiments, opinion leaders disclose programs recommended for the user as timer recording pattern information. However, those who recommend programs are not limited to opinion leaders, but any criteria for selecting programs and any people who recommend programs may be used insofar as they are clear to the user and do not make the user anxious. Those who recommend programs may be organizations such as companies or the like. Programs obtained as a result of some data processing performed by a computer may be recommended as timer recording pattern information.

While preferred embodiments of the present invention have been described using specific terms, such description is for illustrative purposes only, and it is to be understood that changes and variations may be made without departing from the spirit or scope of the invention.

What is claimed is:

1. A method of selecting a program which meets a user's taste from broadcast programs and recording the selected program in automatic broadcast recording apparatus in a system having a server and the automatic broadcast recording apparatus, comprising the steps of:
at said server:
disclosing timer recording pattern information for recording programs recommended by an opinion leader who serves to recommend the programs to be appreciated to the user;
at each of said automatic broadcast recording apparatus:
acquiring said timer recording pattern information of the opinion leader selected by said user;
setting timer recording for a program determined by said timer recording pattern information; and
receiving the program set for timer recording and recording the received program.

2. A method according to claim 1, wherein said broadcast programs include video data and audio data.

3. A method according to claim 1, wherein said broadcast programs include audio data.

4. A method according to claim 1, further comprising the step of:
acquiring program information including identification codes of the broadcast programs and broadcasting dates and times thereof at each of said automatic broadcast recording apparatus;
wherein said timer recording pattern information includes identification codes of the programs recommended by said opinion leader; and
wherein said step of setting timer recording for a program determined by said timer recording pattern information at each of said automatic broadcast recording apparatus includes the step of selecting the program from said program information.

5. A method according to claim 1, wherein said timer recording pattern information includes start-of-program times and end-of-program times of the programs recommended by the opinion leader; and
wherein said step of setting timer recording for a program determined by said timer recording pattern information at each of said automatic broadcast recording apparatus includes the step of selecting the program from the start-of-program time and end-of-program time thereof.

6. A method according to claim 1, further comprising the steps of:
at each of said automatic broadcast recording apparatus:
recording a playback history including information of whether the recorded program is played back or not; and
selecting an opinion leader who meets the user's taste based on said playback history.

7. A method according to claim 1, further comprising the steps of:
at each of said automatic broadcast recording apparatus:
recording a timer recording history including information of programs set for timer recording; and
selecting an opinion leader who meets the user's taste based on said timer recording history.

8. A method according to claim 1, further comprising the steps of:
at each of said automatic broadcast recording apparatus:
recording a recording history including information of recorded programs; and
selecting an opinion leader who meets the user's taste based on said recording history.

9. A method according to claim 4, further comprising the steps of:
at each of said automatic broadcast recording apparatus:
confirming the broadcasting date and time of a program to be recorded from said program information when the program information is acquired, and correcting the broadcasting date and time if the broadcasting date and time have been changed.

10. A method of accumulating programs which meet a user's taste in a system having a server and automatic broadcast recording apparatus by recording broadcast programs in the automatic broadcast recording apparatus, comprising the steps of:
at each of said automatic broadcast recording apparatus:
sending information of playback statuses of recorded programs to said server;
at said server:
collecting said information of each program sent from each of said automatic broadcast recording apparatus of respective users, and calculating a taste level indicative of how much each program meets the user's taste;
sending said taste level to each of said automatic broadcast recording apparatus of respective users; and
at each of said automatic broadcast recording apparatus:
deleting recorded programs successively from programs of lower taste levels.

11. A method according to claim 10, wherein said information includes information of whether each of the recorded programs has been played back to its end or not.

12. A method according to claim 10, wherein said information includes information of whether each of the recorded programs has been deleted or not.

13. A method of accumulating programs which meet a user's taste by recording broadcast programs in a system having a server and automatic broadcast recording apparatus, comprising the steps of:
at each of said automatic broadcast recording apparatus:
sending information of playback statuses of recorded programs to said server;
at said server:
collecting said information of each program sent from each of said automatic broadcast recording apparatus of respective users, and calculating a taste level indicative of how much each program meets the user's taste;
sending said taste level to each of said automatic broadcast recording apparatus of respective users;
at each of said automatic broadcast recording apparatus:
if a program recorded in the past needs to be deleted in order to record a new program, comparing a predetermined taste level given to said new program with the taste level of the program recorded in the past;
if there is a program whose taste level is lower than said new program among programs recorded in the past, deleting the program whose taste level is lower than said new program, and recording the new program; and
if there is no program whose taste level is lower than said new program among programs recorded in the past, stopping recording said new program.

14. A method according to claim 13, wherein said information includes information of whether each of the recorded programs has been played back to its end or not.

15. A method according to claim 13, wherein said information includes information of whether each of the recorded programs has been deleted or not.

16. A method of accumulating programs which meet a user's taste in a system having a server and automatic broadcast recording apparatus, comprising the steps of:
at each of said automatic broadcast recording apparatus:
sending information of playback statuses of recorded programs to said server;
at said server:
collecting said information of each program sent from each of said automatic broadcast recording apparatus of respective users in each of groups of users having similar appreciating histories, and calculating, in each of said groups, a taste level indicative of how much each program meets the user's taste;
sending said taste level to each of said automatic broadcast recording apparatus of the users belonging to the respective groups; and
at each of said automatic broadcast recording apparatus:
deleting recorded programs successively from programs of lower taste levels.

17. A method according to claim 16, wherein said information includes information of whether each of the recorded programs has been played back to its end or not.

18. A method according to claim 16, wherein said information includes information of whether each of the recorded programs has been deleted or not.

19. A method of accumulating programs which meet a users taste in a system having a server and automatic broadcast recording apparatus, comprising the steps of:
at each of said automatic broadcast recording apparatus:
sending information of playback statuses of recorded programs to said server;
at said server:
collecting said information of each program sent from each of said automatic broadcast recording apparatus of respective users in each of groups of users having similar appreciating histories, and calculating, in each of said groups, a taste level indicative of how much each program meets the user's taste;
sending said taste level to each of said automatic broadcast recording apparatus of the users belonging to the respective groups; and
at each of said automatic broadcast recording apparatus:
if a program recorded in the past needs to be deleted in order to record a new program, comparing a predetermined taste level given to said new program with the taste level of the program recorded in the past;
if there is a program whose taste level is lower than said new program among programs recorded in the past, deleting the program whose taste level is lower than said new program, and recording the new program; and
if there is no program whose taste level is lower than said new program among programs recorded in the past, stopping recording said new program.

20. A method according to claim 19, wherein said information includes information of whether each of the recorded programs has been played back to its end or not.

21. A method according to claim 19, wherein said information includes information of whether each of the recorded programs has been deleted or not.

22. A method of selecting a program which meets a user's taste from broadcast programs and recording the selected program in automatic broadcast recording apparatus in a system having a server and the automatic broadcast recording apparatus, comprising the steps of:
at said server:
disclosing timer recording pattern information for recording programs selected according to respective predetermined selecting standards from the broadcast programs;
at each of said automatic broadcast recording apparatus:
acquiring said timer recording pattern information selected by said user;
setting timer recording for a program determined by said timer recording pattern information; and
receiving the program set for timer recording and recording the received program.

23. An apparatus for automatically selecting and recording a program which meets a user's taste from broadcast programs, comprising:
information acquiring means for acquiring timer recording pattern information for recording programs recommended by an opinion leader who is selected by the user and serves to recommend the programs to be appreciated to the user;
timer recording means for setting timer recording for a program determined by said timer recording pattern information;
receiving means for receiving the program set for timer recording; and
recording and playing means for recording the program.

24. An apparatus according to claim 23, wherein said broadcast programs include video data and audio data.

25. An apparatus according to claim 23, wherein said broadcast programs include audio data.

26. An apparatus according to claim 23, wherein said timer recording pattern information includes identification codes of the programs recommended by said opinion leader, said information acquiring means acquires program information including identification codes of the broadcast programs and broadcasting dates and times thereof, and said timer recording means selects the program determined by said timer recording pattern information from said program information and sets timer recording for the selected program.

27. An apparatus according to claim 23, wherein said timer recording pattern information includes start-of-program times and end-of-program times of the programs recommended by the opinion leader, and said timer recording means sets timer recording for the program determined by said timer recording pattern information according to the start-of-program time and end-of-program time thereof.

28. An apparatus according to claim 23, wherein said recording and playing means records a playback history including information of whether the recorded program is played back or not, and selects an opinion leader who meets the user's taste based on said playback history.

29. An apparatus according to claim 23, wherein said timer recording means records a timer recording history including information of programs set for timer recording, and selects an opinion leader who meets the user's taste based on said timer recording history.

30. An apparatus according to claim 23, wherein said recording and playing means records a recording history including information of recorded programs, and selects an opinion leader who meets the user's taste based on said recording history.

31. An apparatus according to claim 26, wherein said timer recording means confirms the broadcasting date and time of a program to be recorded from said program information when the program information is acquired by said information acquiring means, and corrects the broadcasting date and time if the broadcasting date and time has been changed.

32. An apparatus for accumulating programs which meet a user's taste by recording broadcast programs, comprising:
recording and reproducing means for sending information of playback statuses of recorded programs to a server, which calculates a taste level indicative of how much each program meets the user's taste, and deleting recorded programs successively from programs of lower taste levels sent from said server, when recorded programs are to be deleted; and
information acquiring means for receiving said taste level from said server which has collected said information of each program sent from each of respective users.

33. An apparatus according to claim 32, wherein said information includes information of whether each of the recorded programs has been played back to its end or not.

34. An apparatus according to claim 32, wherein said information includes information of whether each of the recorded programs has been deleted or not.

35. An apparatus for accumulating programs which meet a user's taste by recording broadcast programs, comprising:
recording and playing means for sending information of playback statuses of recorded programs to a server, which calculates a taste level indicative of how much each program meets the user's taste, and, if a program recorded in the past needs to be deleted in order to record a new program, comparing a predetermined taste level given to said new program with the taste level of the program recorded in the past, and if there is a program whose taste level is lower than said new program among programs recorded in the past, deleting the program whose taste level is lower than said new program, and recording the new program, and if there is no program whose taste level is lower than said new program among programs recorded in the past, stopping recording said new program; and
information acquiring means for receiving said taste level from said server which has collected said information of each program sent from each of respective users.

36. An apparatus according to claim 35, wherein said information includes information of whether each of the recorded programs has been played back to its end or not.

37. An apparatus according to claim 35, wherein said information includes information of whether each of the recorded programs has been deleted or not.

38. An apparatus for selecting a program which meets a user's taste from broadcast programs, comprising:
information acquiring means for acquiring timer recording pattern information selected by the user among timer recording pattern information for recording programs selected according to respective predetermined selecting criteria;
timer recording means for setting timer recording for a program determined by said timer recording pattern information;
receiving means for receiving the program set for timer recording; and
recording means for recording the received program.

39. A computer program for enabling a computer to perform a process of providing a user with information to select a program which meets the user's taste, comprising:
an instruction set for disclosing a web page through a communication network;
an instruction set for storing, in a memory, timer recording pattern information for recording programs recommended by an opinion leader who serves to recommend the programs to be appreciated to the user; and
an instruction set for displaying the timer recording pattern information on said web page for each opinion leader.

40. A computer program according to claim 39, wherein said timer recording pattern information includes identification codes of the programs recommended by said opinion leader.

41. A computer program according to claim 39, wherein said timer recording pattern information includes start-of-program times and end-of-program times of the programs recommended by the opinion leader.

42. A computer program for enabling a computer to perform a process of providing a user with information to select a program which meets the user's taste, comprising:
an instruction set for receiving information of playback statuses of recorded programs from a plurality of users;
an instruction set for collecting said information of each program sent from each of said users, and calculating a taste level indicative of how much each program meets the user's taste; and
an instruction set for sending said taste level to each of said users.

43. A computer program according to claim 42, wherein said information includes information of whether each of the recorded programs has been played back to its end or not.

44. A computer program according to claim 42, wherein said information includes information of whether each of the recorded programs has been deleted or not.

45. A computer program for enabling a computer to perform a process of providing a user with information to select a program which meets the user's taste, comprising:
an instruction set for receiving information of playback statuses of recorded programs from each user;
an instruction set for collecting said information of each program sent from each user in each of groups of users having similar appreciating histories, and calculating, in each of said groups, a taste level indicative of how much each program meets the user's taste; and
an instruction set for sending said taste level to each of the users belonging to the respective groups in said server.

46. A computer program according to claim 45, wherein said information includes information of whether each of the recorded programs has been played back to its end or not.

47. A computer program according to claim 45, wherein said information includes information of whether each of the recorded programs has been deleted or not.

48. A computer program for enabling a computer to perform a process of providing a user with information to select a program which meets the user's taste, comprising:
an instruction set for disclosing a web page through a communication network;
an instruction set for storing, in a memory, timer recording pattern information for the user to record programs selected according to respective predetermined selecting standards; and
an instruction set for displaying each said timer recording pattern information on said web page.
